(19) United States
(12) Patent Application Publication
(10) Pub. No.: US 2026/0244018 A1
(43) Pub. Date: Aug. 20, 2026

(54) DISPLAY DEVICE HAVING A HOLDING DEVICE WHICH CAN BE PLACED ON THE HEAD OF A USER

(71) Applicant: tooz technologies GmbH, Aalen (DE)

(72) Inventors: Michael POLLMANN, Koenigsbronn (DE); Georg MICHELS, Aalen (DE)

(21) Appl. No.: 19/160,430

(22) PCT Filed: Feb. 21, 2024
(86) PCT No.: PCT/EP2024/054365

§ 371 Date: Aug. 27, 2025

(30) Foreign Application Priority Data
Feb. 27, 2023 (DE) 10 2023 104 698.5

(51) Int. Cl. G02B 27/01

(52) U.S. Cl. CPC G02B 27/0172; G02B 27/0176; G02B 2027/0178

(57) ABSTRACT

A display device includes a holding device, which can be placed on the head of a user, a first and a second image-generating module, which are fastened to the holding device and generate a first and a second image, and a first and a second spectacle lens fastened to the holding device. In the state in which the holding device is placed on the head, the generated first image is presented to the user via the first spectacle lens in the form of a first virtual image and the generated second image is presented to the user via the second spectacle lens in the form of a second virtual image. The first and the second virtual image are presented to the user such that the images do not together impart a three-dimensional image display.

### PRIORITY

This application claims the priority of German patent application DE 10 2023 104 698.5 filed Feb. 27, 2023, which is hereby incorporated herein by reference in its entirety.

### FIELD

The present invention relates to a display device having a holding device which can be mounted on the head of a user, a first and second image generation module, which are attached to the holding device and generate a first and a second image, and a first and second spectacle lens attached to the holding device, wherein the user is shown in the head-mounted state of the holding device the generated first image via the first spectacle lens as the first virtual image and the generated second image via the second spectacle lens as the second virtual image.

### BACKGROUND

In such display devices, the two virtual images are presented to the user in such a way that a three-dimensional image impression is present for the user. Although this is very impressive for the user, it places high demands on the optics unit and manufacturing tolerances in order to be able to ensure the desired three-dimensional image impression.

### SUMMARY

An object of the invention to further develop such a display device in the manner such that lower demands can be placed on the optics unit and the manufacturing tolerances.

The display device according to certain embodiments may comprise a holding device, which can be mounted on the head of a user, a first image generation module, which is attached to the holding device and generates a first image, a second image generation module, which is attached to the holding device and generates a second image, a first spectacle lens, which is attached to the holding device and has a first deflection section, and a second spectacle lens, which is attached to the holding device and has a second deflection section. Furthermore, the generated first image can be deflected at the first deflection section in such a way that the user can perceive it with a first eye as the first virtual image in the head-mounted state of the holding device. In the same way, the generated second image can be deflected at the second deflection section in such a way that it can be perceived by the user with the second eye as a second virtual image in the head-mounted state of the holding device. The first and second virtual images can be presented to the user with the display device in such a way that they together convey no three-dimensional image representation to the user.

There is therefore no three-dimensional image representation. Instead, the right and left eye can be deliberately shown different (and preferably non-overlapping) virtual images. Similar to a purely monocular case in which only one image is presented to the user via one of the spectacle lenses, the user does not consciously perceive the one-sided display of the images. For the user, the dual monocular design effectively results in a larger field of view (FOV)—twice as large as in the monocular case, when both virtual images are the same size. Since no binocular image impression is to be generated, no vergence condition has to be adhered to in an advantageous manner, which makes the system design (especially in optical terms) significantly easier and significantly reduces risks with regard to user comfort.

Presenting the first and second virtual images in such a way that they together do not convey a three-dimensional image representation to the user is understood here in particular to mean that this is achieved by the relative position of the two virtual images to each other, by a non-existent vergence condition, and/or by the image contents of the two virtual images.

The first and second virtual images can be presented to the user spaced apart from each other in such a way that there is a gap between them. This means in particular that the presented contents of the two virtual images do not overlap. However, it is quite possible that the presented contents of the two virtual images partially overlap. In this case, the partial overlap is preferably less than 20%, 15%, 10%, 5%, 4%, 3%, 2% or 1% of the surface area of the first and/or second virtual image.

Both the first image generation module together with the first spectacle lens and also the second image generation module with the second spectacle lens can each be designed as a monocular basic system. This is understood here in particular to mean that with the two monocular basic systems, the first virtual image for the right eye and the second virtual image for the left eye are presented to the user in such a way that the two virtual images are spaced apart from each other such that there is a gap between the two images. In particular, different images or image contents can be represented with the two virtual images. Preferably, the representation can be accomplished in such a way that the user cannot perceive the two virtual images at a specific distance as just a single image.

The display device can present to the user or superimpose for the user the first and second virtual images spaced apart from each other in the horizontal direction. Furthermore, the display device can display to the user or superimpose for the user the first and second virtual images spaced apart from each other in the vertical direction.

The display device may be designed such that the first and second virtual images are presented in the same focus plane or in different focus planes (which preferably have different distances from the respective eye pupil).

The first and/or second generated image may be guided, for example, by at least one reflection in the corresponding spectacle lens to the deflection section. For this purpose, the first spectacle lens may have a first entry section, the first deflection section spaced apart therefrom, and a first exit section, and the second spectacle lens may have a second entry section, the second deflection section spaced apart therefrom, and a second exit section. Thus, the generated first image can be coupled into the first spectacle lens via the first entry section, be guided in the first spectacle lens by at least one reflection to the first deflection section, and be coupled out of the first spectacle lens via the first exit section by deflection at the first deflection section in such a way that the user can perceive it with a first eye as the first virtual image in the head-mounted state of the holding device. In the same way, the generated second image can be coupled into the second spectacle lens via the second entry section, be guided in the second spectacle lens by at least one reflection to the second deflection section, and be coupled out of the second spectacle lens via the second exit section by deflection at the second deflection section in such a way that the user can perceive it with the second eye as a second virtual image in the head-mounted state of the holding device.

Instead of such guidance in the first or second spectacle lens, the display device may be designed such that the first and/or second generated image is directed (preferably directly) at the first or second deflection section, which brings about the desired deflection. Such a design can be referred to as a free-space combiner.

The first deflection section and the second deflection section can cause the desired deflection reflectively, refractively and/or diffractively. Thus, the first deflection section may be designed as a reflective, refractive and/or diffractive deflection section. The same applies to the second deflection section. A diffractive deflection section may, for example, have a surface grating or a volume hologram. Furthermore, a diffractive deflection section may be designed, for example, as a surface grating or as a volume hologram.

A sensor, which measures the inclination of the holding device, may be arranged on the holding device, wherein either only the first virtual image or only the second virtual image is presented, depending on the measured inclination.

The display device can present to the user an input interface through which the user can specify to the display device that only the first virtual image or only the second virtual image be represented.

The display device can present the first virtual image to the user's right eye and the second virtual image to the user's left eye in such a way that both images do not overlap. The FOV possible here depends on the geometric design of the display device (depending on the pupil distance of the user, the focus plane of the virtual images, the axis in which the virtual images appear (line of sight, LOS), and the desired orientation of the two virtual images to each other).

In the first and/or second spectacle lens, the deflection section may comprise a single reflective deflection element or a plurality of adjacent reflective deflection elements. With a plurality of adjacent reflective deflection elements, a desired deflection function and, if necessary, a specific imaging function of the deflection section can be realized, for example, in a Fresnel-like manner (this can of course also be realized with a single reflective deflection element). The reflective deflection elements can be reflective surface pieces, which can also be referred to as reflective facets. The reflective surface pieces can be planar in each case. However, it is also possible that the reflective surface pieces themselves are curved (for example spherically or aspherically curved). In the same way, the single reflective deflection element may be planar or curved (for example, spherically or aspherically curved).

For example, the reflectivity of the respective reflective deflection elements (or the single reflective deflection element) can be in the range of 2-100% (including the limits of the range) for the respective wavelength or color. Thus, the reflective deflection elements can be partially reflective or reflective.

The first and/or second spectacle lens may in particular have a curved rear side and/or a curved front side. The entry section may be formed in the rear side.

The light beams of the corresponding image generation module are preferably guided by one or more reflections (in particular total internal reflections) to the deflection section. The one or more reflections or total internal reflections can be realized, for example, at the front side and/or rear side of the first or second spectacle lens. However, it is also possible that at least one of the reflections or total internal reflections is brought about at a layer buried in the first or second spectacle lens, which layer is spaced apart from the front side and rear side.

The first or second image generation module can generate a monochromatic first or second image or a multicolor first or second image.

The display device may have a control unit, which controls the first and second image generation module. In particular, the control unit can control the first and second image generation module based on supplied image data.

The first and/or second image generation module (or the corresponding imager unit of the respective image generation module) may in particular comprise a surface-type imager, such as an LCD module, an LCoS module, an OLED module, a μLED or a tilt mirror matrix. Each imager can have a plurality of pixels, which can be arranged, for example, in rows and columns. For example, each imager can be self-luminous or non-self-luminous.

Each imager can preferably generate a monochromatic image, wherein different imagers generate monochromatic images with different wavelengths.

The first and/or second image generation module may have, for example, a polychromatic imager, a combination of two or more monochromatic imagers, or a combination of a duochromatic imager and a monochromatic imager. Typical configurations of such image generation modules with a plurality of imagers have an overlaying unit that overlays the light beams from the plurality of imagers into a common light beam. Such an overlaying unit can be realized, for example, as a beam splitter cube (also called X-cube) or as a so-called rod combiner, which are known to a person skilled in the art.

Since the output coupling deflection section is to be as invisible as possible and the light coming from the environment to the eye of the observer is also to be negatively influenced as little as possible, deflection sections which have a high transmittance in transmitted light and associated therewith have a low reflectivity for the light beam, which is to be coupled out, of the at least two-color image are generally preferred. Typical values for the ratio of reflection to transmission are 50%, 30%, 10% or 2%, uniform over the visible wavelength range.

It will be apparent that the features mentioned above and those still to be elucidated below are usable not just in the combinations specified but also in other combinations or on their own, without leaving the scope of the present invention.

The invention will be elucidated in greater detail hereinafter using exemplary embodiments with reference to the appended drawings, which likewise disclose features essential to the invention. These exemplary embodiments serve merely for elucidation and should not be interpreted in a restrictive manner. For example, a description of an exemplary embodiment having a multitude of elements or components should not be interpreted to mean that all these elements or components are necessary for implementation. Instead, other exemplary embodiments may also contain alternative elements and components, fewer elements or components, or additional elements or components. Elements or components from different exemplary embodiments may be combined with one another, unless stated otherwise. Modifications and variations that are described for one of the exemplary embodiments may also be applicable to other exemplary embodiments. To avoid repetition, identical or mutually corresponding elements in different figures are given the same reference signs and not be elucidated again.

### BRIEF DESCRIPTION OF THE DRAWINGS

FIG. 1 is a schematic perspective illustration of an embodiment of the display device according to certain embodiments of the invention;

FIG. 2 is an enlarged partial sectional view of the first spectacle lens including a schematic illustration of the first image generation module;

FIG. 3 is an enlarged partial sectional view of the second spectacle lens including a schematic illustration of the second image generation module;

FIG. 4 is an illustration elucidating a possible arrangement of the first and second virtual images;

FIG. 5 is a schematic illustration of an embodiment of the display device according to certain embodiments of the invention;

FIGS. 6-10 are illustrations for elucidating possible arrangements of the first and second virtual images; and

FIG. 11 is an enlarged partial sectional view of the first spectacle lens including a schematic illustration of the first image generation module according to a further embodiment of the display device according to certain embodiments of the invention.

### DETAILED DESCRIPTION

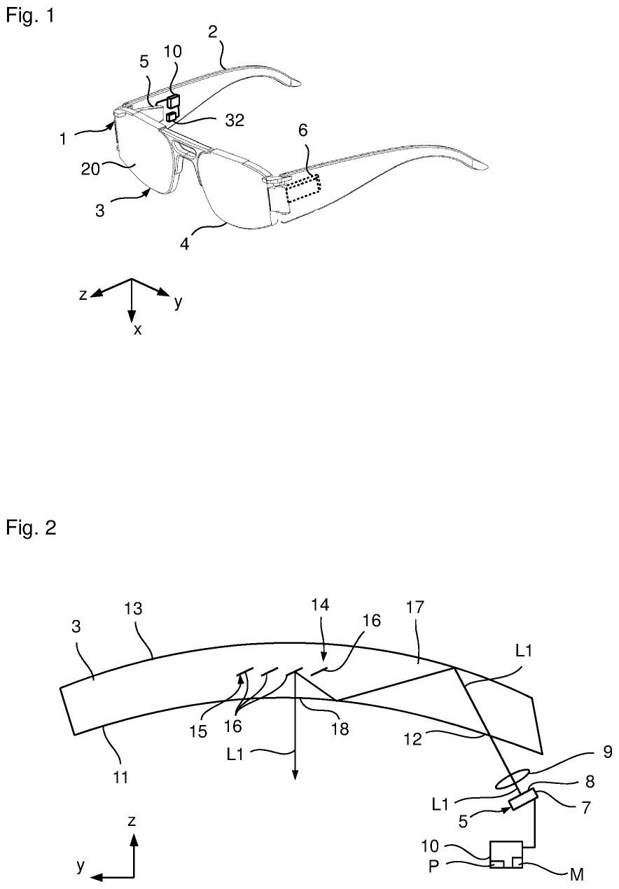

In the embodiment shown in FIG. 1, the display device 1 comprises a holding device 2 which can be mounted on the head of a user and which may be designed, for example, in the manner of a conventional spectacle frame, and a first and a second spectacle lens 3, 4, which are attached to the holding device 2. The holding device 2 with the spectacle lenses 3, 4 can be designed, for example, as sports glasses, sunglasses, and/or eyeglasses for the correction of defective vision, wherein a respective virtual image can be superimposed into the field of view of the user via the first and second spectacle lens 3, 4, which can each also be referred to as a multifunctional lens, as described below.

For this purpose, the display device 1 comprises a first image generation module 5, which can be arranged in the region of the right eyeglass temple of the holding device 2, and a second image generation module 6, which can be arranged in the region of the left eyeglass temple of the holding device 2, as shown schematically in FIG. 1.

The first image generation module 5 may have a first imager unit 7 for generating a first image, as shown schematically in FIG. 2. For this purpose, the imager unit 7 comprises a first surface-type image generation element 8, downstream of which a first imager optics unit 9 is arranged. Alternatively, the first imager optics unit 9 may be integrated into the first spectacle lens 3 (not shown). The first surface-type image generation element 8 may comprise, for example, an OLED element, a μLED, an LCD element, an LCOS element or a tilt mirror matrix, each of which comprises a multiplicity of pixels arranged, for example, in rows and columns. As representative for the light beams emitted from the first surface-type image generation element 8, a single light beam L1 is drawn in each case schematically.

As can be further seen in FIG. 2, a control unit 10 with, for example, a processor P and a memory M for controlling the first image generation module 5 is provided. The control unit 10, which can be arranged, for example, on the holding device 2, controls, depending on supplied image data, the first image generation module 5 and in particular the first image generation elements 8 in such a way that a first image is generated according to the image data. The light beams L1 emitted in the process by the first image generation element 8 travel through the first imager optics unit 9 and then enter the first spectacle lens 3 via a curved rear side 11 thereof. The region of the entrance at the rear side 11 can also be referred to as entry section 12.

The first spectacle lens 3 further has a curved front side 13 and a first deflection section 14, which is buried in the first spectacle lens 3. The first deflection section 14 comprises a first reflective deflection structure 15 having a plurality of first reflective deflection elements 16, which can also be referred to as the first reflective facets.

As has already been described, the light beams L1 enter the first spectacle lens 3 via the entry section 12 in the rear side 11. The light beam L1 is then guided in the first spectacle lens 3, e.g. by total internal reflection at the rear side 11 and front side 13 to the first deflection section 14, such that a first light guide channel 17 from the entry section 12 to the first deflection section 14 is present. The first deflection section 14 then deflects the light beam L1 toward the rear side 11 in such a way that the deflected light beams L1 exit from the first spectacle lens 3 via the rear side 11. The region via which the light beams L1 exit can also be referred to as exit section 18.

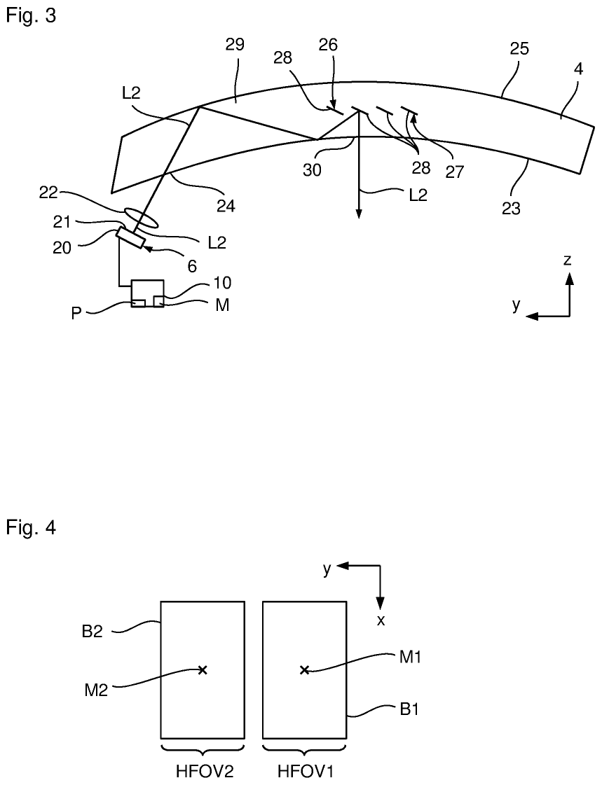

The second image generation module 6 can, as shown schematically in FIG. 3, have a second imager unit 20 for generating a second image. For this purpose, the second imager unit 20 comprises a second surface-type image generation element 21, downstream of which a second imager optics unit 22 is arranged. The second surface-type image generation element 21 may comprise, for example, an OLED element, a μLED, an LCD element, an LCOS element or a tilt mirror matrix, each of which comprises a multiplicity of pixels arranged, for example, in rows and columns. As representative for the light beams emitted from the second surface-type image generation element 21, a single light beam L2 is drawn in each case schematically.

As can be further seen from FIG. 3, the control unit 10 is also provided for controlling the second image generation module 6. The control unit 10 controls, depending on supplied image data, the second image generation module 6 and in particular the second image generation elements 21 in such a way that a second image is generated according to the image data. The light beams L2 emitted in the process by the second image generation element 21 travel through the second imager optics unit 22 and then enter the second spectacle lens 4 via a curved rear side 23 thereof. The region of the entrance at the rear side 23 can also be referred to as entry section 24.

The second spectacle lens 4 further comprises a curved front side 25 and a second deflection section 26, which is buried in the second spectacle lens 4. The second deflection section 26 comprises a second reflective deflection structure 27 having a plurality of second reflective deflection elements 28, which can also be referred to as second reflective facets.

As has already been described, the light beams L2 enter the second spectacle lens 4 via the entry section 24 in the rear side 23. The light beams L2 are then guided in the second spectacle lens 4, e.g. by total internal reflection at the rear side 23 and front side 25 to the second deflection section 14, such that a second light guide channel 29 from the entry section 24 to the second deflection section 26 is present. The second deflection section 26 then deflects the light beams L2 to the rear side 23 in such a way that the deflected light beams L2 exit from the second spectacle lens 4 via the rear side 23. The region via which the light beams L2 exit can also be referred to as exit section 30.

The first image generation module 5 and the first spectacle lens 3 and also the second image generation module 6 and the second spectacle lens 5 are designed such that a user wearing the display device 1 on the head can perceive the first image generated by means of the first image generation module 5 as the first virtual image B1 with their first eye (here the right eye) and can perceive the second image generated by means of the second image generation module 6 as the second virtual image B2 with their second eye (here the left eye), as schematically illustrated in FIG. 4.

In the display device 1, both the first image generation module 5 together with the first spectacle lens 3 and the second image generation module 6 with the second spectacle lens 5 are each designed as a monocular basic system. In particular, this is understood to mean that the first virtual image B1 is presented to the user for the right eye and the second virtual image B2 for the left eye with the two basic monocular systems in such a way that the two virtual images B1 and B2 are spaced apart from each other, such that a gap exists between the two images, as schematically illustrated in FIG. 4. In particular, the two virtual images B1 and B2 can represent different images. Preferably, the representation is such that the user cannot perceive the two virtual images B1 and B2 as just a single image at a specific distance. There is therefore no three-dimensional image representation. Instead, the right and left eyes can be deliberately shown different, non-overlapping virtual images B1 and B2. Similar to a purely monocular case in which only one image is presented to the user via one of the spectacle lenses, the user does not consciously perceive the one-sided display of the images B1 and B2. For the user, the doubly monocular design effectively results in a larger field of view-twice as large as in the monocular case, when both virtual images B1 and B2 are equal in size. Since no binocular image impression is to be generated, no vergence condition has to be adhered to in an advantageous manner, which makes the system design (especially in optical terms) significantly easier and significantly reduces risks with regard to user comfort.

As a property of the display device 1, a deliberate separation of the virtual images B1 and B2 presented for the right and left eyes can thus be specified. A distance between the virtual images B1 and B2 should be deliberately established, since even an exact abutment between the virtual images B1 and B2 would place very high demands on the tolerances of the display device 1. Also unavoidable differences in user physiognomies (head width, pupil distance, etc.) of different users place high demands on the design of the optical system. This can be deliberately avoided by separating the regions in which the two virtual images B1 and B2 are represented.

If the virtual images B1 and B2 are to be prevented from overlapping, then in the case of a horizontal distance between the virtual images B1, B2 the half horizontal FOV (HFOV) must not be larger than:

$$\frac{1}{2} HFOV < 90 ° - arc sin ( \frac{V I D cos {β}_{L O S}}{\sqrt{{( V I D cos {β}_{L O S} )}^{2} + \frac{1}{4} P {D}^{2}}} ) + {β}_{L O S}$$

wherein
VID: distance between eye pupil and center M1, M2 of the virtual image B1, B2;
PD: pupil distance between the two eye pupils;
β_{LOS}: angle between straight-ahead viewing direction G1, G2 and direction VID1, VID2, in which the user looks at the center of the virtual image B1, B2.

This applies to the right and left eyes when the focus planes of the two virtual images B1 and B2 are identical.

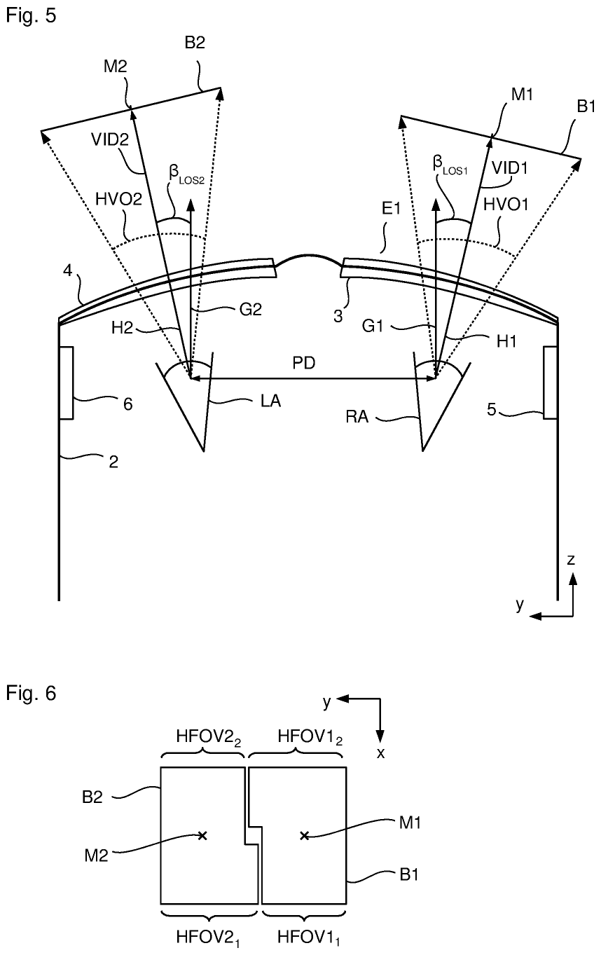

However, the focus planes for the two virtual images B1 and B2 presented to the right and left eyes do not necessarily need to be identical. If different planes are represented deliberately, as shown schematically in FIG. 5 (wherein the corresponding variables are distinguished by the addition “1” or “2,” such as e.g. VID1 and VID2), different VIDs (specifically VID1 and VID2) must be applied for the right and left eyes.

Since the two monocular basic systems (first image generation module 5 together with the first spectacle lens 3 on the one hand and second image generation module 6 with the second spectacle lens 5 on the other) are each designed to be monocular, the display device 1 may also be designed by a user such that the user can, for example, specify via the control unit 10 whether only the first virtual image B1 or only the second virtual image B2 should be generated and represented. In the normal case, every person has a so-called dominant eye. This eye determines the direction that the other eye will follow. This allows the user to select the eye side where the user can better perceive the monocular virtual image B1 or B2.

To select the appropriate monocular basic system, a corresponding input interface can be provided by the control module 10 itself or by separate software that can communicate with the control module 10. For example, an appropriate program can be provided that runs on a computer and/or a so-called smartphone.

In the previously described embodiment, the display device 1 was designed such that the two virtual images B1 and B2 for the left and right eyes lie horizontally at the same height (seen in the x-direction) and that both virtual images B1, B2 have a constant horizontal extent (in the y-direction). However, it is also possible that the two virtual images B1, B2 do not have a constant horizontal extent, as shown schematically in FIG. 6. Both virtual images B1, B2 each have two different horizontal extents HFOV1₁, HFOV1₂, HFOV2₁, HFOV2₂ and are arranged such that they do not overlap. There is always a distance or gap between the two virtual images B1, B2.

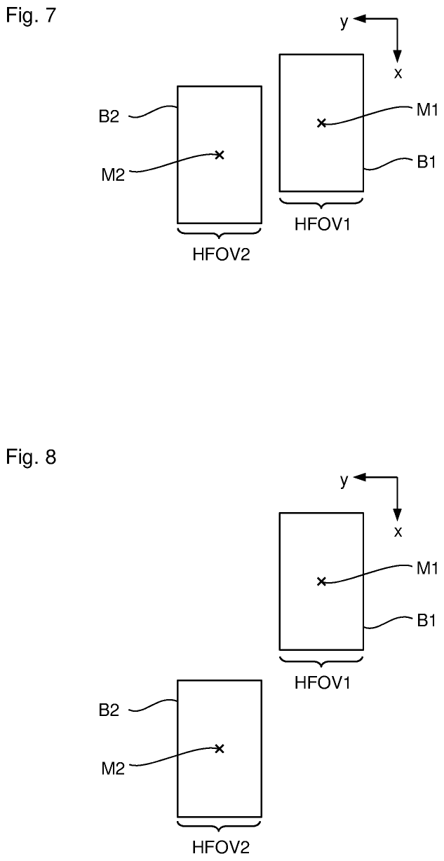

However, it is also possible to differently align the virtual images B1 and B2 vertically, as schematically illustrated in FIG. 7. In this alignment, the left virtual image B2 is vertically lower than the right virtual image B1. Of course, this can also be the other way around.

This may cause the user's head to be more horizontal or tilted down. This would change the optimal positioning of the virtual image compared to the outside world. Due to the design described, the data can therefore be represented higher or lower depending on the usage situation.

In particular, a sensor 32 (FIG. 1) can be provided at the display device 1, which sensor measures the alignment of the display device 1 and thus of the user's head and transmits it to the control unit 10, which, depending on this, represents the corresponding data as the first virtual image B1 or as the second virtual image B2.

In the design schematically shown in FIG. 7 of the display device 1, the two virtual images B1 and B2 are shifted in the vertical direction (x-direction) in such a way that both images B1 and B2 partially have the same vertical values. However, it is also possible that both virtual images B1 and B2 do not have the same values even in the vertical direction, as shown schematically in FIG. 8.

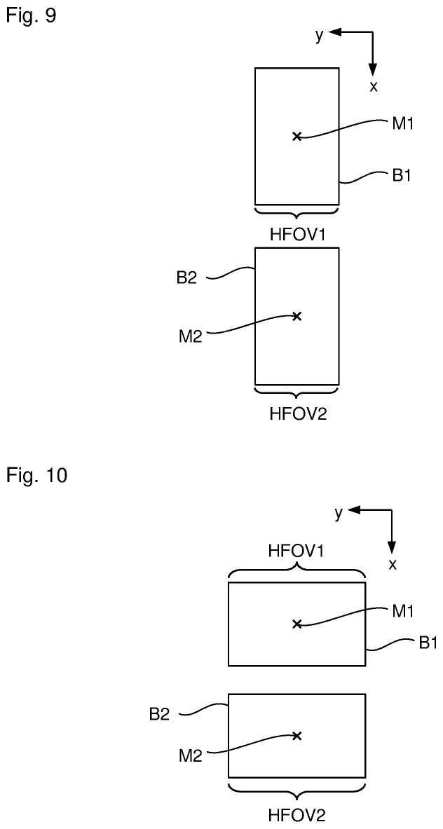

Furthermore, the two virtual images B1 and B2 can be represented in such a way that they are spaced apart in the vertical direction, but cover the same viewing angles in the horizontal direction, as shown in FIG. 9. Of course, it would also be possible to arrange the two virtual images B1 and B2 according to FIG. 9 in such a way that they are offset in a horizontal direction relative to each other.

Of course, the alignment of the images B1 and B2 can also be changed, as schematically illustrated in FIG. 10. In this case, the aspect ratio (ratio of extent in the x-direction to extent in the y-direction) is chosen differently.

The imager units 7 and 20 may be designed to generate and output a monochromatic (and thus single-color) image. However, they can also be designed to indicate a multicolor image.

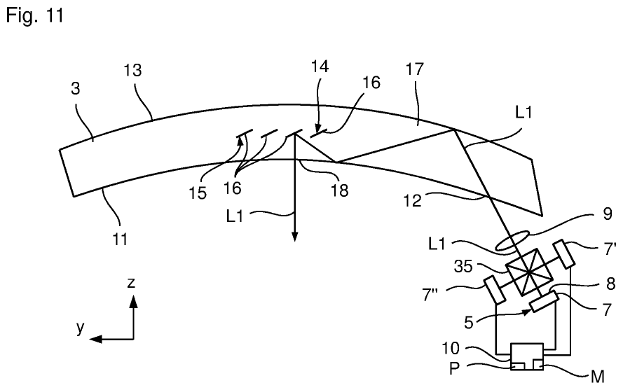

Furthermore, it is possible to provide a plurality of imager units 7, 7′ and 7″ (FIG. 11), which, for example, generate and output a red, green and blue partial image that is then overlaid by means of an overlaying unit 35 (for example, a color-combiner cube) to obtain a common beam L1, as shown for the first image generation module 5 in FIG. 2. Of course, if desired, the second image generation module 6 can in the same manner or even only alternatively be designed in the manner described.

Depending on the reflectivity of the first or second deflection elements 16, 28, the first or second virtual image B1, B2 can be perceived by the user in overlay with the environment. At a very high reflectivity and in particular at a reflectivity of 100%, the user can perceive at least in the region of the first or second deflection section 14, 26 only the first or second virtual image B1, B2 and not the environment if a specific distance of the first and second deflection elements 16, 28 is not exceeded. If the specific distance between adjacent deflection elements 16 or 28 is exceeded, ambient light can reach the eye unhindered between them, so that even at 100% reflectivity of the deflection elements 16 or 28 a view through to the environment is possible, so that as it were a perforated/segmented 100% mirror is present.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-9. (canceled)

10. A display device, comprising:
a holding device capable of being mounted on the head of a user;
a first image generation module, which is attached to the holding device and generates a first image;
a second image generation module, which is attached to the holding device and generates a second image;
a first spectacle lens, which is attached to the holding device and has a first deflection section; and
a second spectacle lens, which is attached to the holding device and has a second deflection section,
wherein the generated first image is deflected at the first deflection section such that the user can perceive the generated first image with a first eye as a first virtual image in the head-mounted state of the holding device,
wherein the generated second image is deflected at the second deflection section such that the user can perceive the generated second image with a second eye as a second virtual image in the head-mounted state of the holding device, and
wherein the first and the second virtual images are presented to the user such that together the first and the second virtual images do not convey a three-dimensional image representation to the user.

11. The display device of claim 10, wherein the first and the second virtual images are presented to the user spaced apart from each other such that there is a gap between the first and the second virtual images.

12. The display device of claim 10, wherein the first and the second virtual images are presented to the user spaced apart from each other in a horizontal direction.

13. The display device of claim 10, wherein the first and second virtual images are presented to the user spaced apart from each other in a vertical direction.

14. The display device of claim 13, wherein a sensor is arranged at the holding device to measure the inclination of the holding device, and wherein either only the first virtual image or only the second virtual image is presented, depending on the measured inclination.

15. The display device of claim 10, wherein the first and the second virtual images are presented in a common focus plane.

16. The display device of claim 10, wherein the first and the second virtual images are presented in different focus planes.

17. The display device of claim 10, wherein the user, via an input interface, specifies to the display device to present only the first virtual image or only the second virtual image.

18. The display device of claim 10, wherein
the first spectacle lens has a first entry section, the first deflection section spaced apart therefrom, and a first exit section,
the second spectacle lens has a second entry section, the second deflection section spaced apart therefrom, and a second exit section,
wherein the generated first image is coupled into the first spectacle lens via the first entry section, is guided in the first spectacle lens by at least one reflection to the first deflection section and is coupled out of the first spectacle lens via the first exit section by deflection on the first deflection section such that the user can perceive the generated first image with a first eye as the first virtual image in the head-mounted state of the holding device, and
wherein the generated second image is coupled into the second spectacle lens via the second entry section, is guided in the second spectacle lens by at least one reflection to the second deflection section and is coupled out of the second spectacle lens via the second exit section by deflection at the second deflection section such that the user can perceive the generated second image with the second eye as the second virtual image in the head-mounted state of the holding device.
